(19) United States
(12) Patent Application Publication
(10) Pub. No.: US 2015/0081777 A1
(43) Pub. Date: Mar. 19, 2015

(54) DYNAMIC CONTENT AGGREGATION

(71) Applicant: SharpShooter/Spectrum Venture LLC, Wheatridge, CO (US)

(72) Inventors: Paul Laine, Zephyr Cove, NV (US); Richard Roy, Breckenridge, CO (US); Charles Roy, Morrison, CO (US); Caine Smith, Grand Cayman - Cayman Islands (GB); Robin Barton, Grand Cayman - Cayman Islands (GB); Russell Steger, Morriston, CO (US); Elizabeth Newnam, Highlands Ranch, CO (US)

(21) Appl. No.: 14/489,263

(22) Filed: Sep. 17, 2014

Related U.S. Application Data
(60) Provisional application No. 61/879,588, filed on Sep. 18, 2013.

(51) Int. Cl. H04L 29/08; H04L 29/06

(52) U.S. Cl. CPC H04L 67/06; H04L 67/42; H04L 67/10
USPC 709/203

(57) ABSTRACT

Methods, systems, and devices for dynamically aggregating content, especially digital content, are described. These include tools and techniques for automatically creating a unique package that tells a user-specific story about memorable life events. Electronic media files such as photographs, videos, and the like, of a user may be captured and linked to a unique identifier. The electronic media files may be transmitted to a central server where they may be aggregated and utilized to generate a multimedia file for user. The multimedia file may include electronic media files captured at disparate locations and times, and it may include stock content, user-generated content, third-party content, and the like. Users may access archived stories (e.g., multimedia files) in a virtual bookshelf Third-parties may be compensated for their content that is provided to a user.

### CROSS REFERENCES

The present Application for Patent claims priority to U.S. Provisional Patent Application No. 61/875,588 by Laine et al., entitled “Dynamic Content Aggregation,” filed Sep. 18, 2013, assigned to the assignee hereof, and expressly incorporated by reference herein.

### BACKGROUND

The following relates generally to aggregating content and, in particular, to dynamically aggregating disparate items of digital content with one or more common attributes. In the realm of digital media—e.g., digital photography, videography, graphic arts, and geo-spatial drafting—it has become increasingly easy to amass large quantities of digital content. It is now possible to create high-quality digital content nearly instantly; and that content may be stored and exchanged with relative ease.

Before the advent of digital media, however, certain industries, such as the tourism industry, relied largely on now-antiquated technologies. A visitor to a large city zoo, for example, may have experienced a scenario like the following. Upon entering the zoo, the visitor may be approached by a photographer (e.g., an employee of the zoo) wielding a 35 mm SLR camera. The zoo photographer might snap a few shots of the visitor and her family. Then, while the visitor toured the zoo, the photographer may prepare a printed proof of the photo for the visitor's review. The visitor, before leaving the zoo for the day, might stop by a kiosk, view the proof, and order one or several prints.

More recently, digital photography has displaced film. But the means of distributing the photos remain largely similar to the scenario described above. Now, the visitor may view a “proof” as a digital image on a screen when she stops by the kiosk. Or, she may visit a website where she can view the proof and purchase a digital or print copy of the photo. Furthermore, and despite the relative technological advances, the tourism industry—and other enterprises—still leave content aggregation largely in the hands of the consumer. Tourists may be offered more, and easier, ways of purchasing content, but it is up to each individual to assemble their own picture albums or scrapbooks.

Whatever life experience a consumer seeks to commemorate—a trip to the zoo, a family ski vacation, a Hawaiian holiday, or an outing to a big league ball park—the consumer herself must still assemble various photos, imagery, and keepsakes. It may therefore be beneficial to automatically, and dynamically, aggregate digital content in a unique package that tells the unique story of a vacation, holiday, adventure, or outing, and which could be provided directly to a consumer.

### SUMMARY

Methods, systems, and devices for dynamically aggregating content, especially digital content, are described. This may include processes and tools for automatically creating a unique package that tells a user-specific story about memorable life moments (e.g., vacations, holidays, adventures, outings, children's activities, and sporting events). The described techniques may utilize unique identifiers, which may be linked to various items of content (e.g., electronic media files). The linked items of content may be associated with a user; and, in some cases, those associations may be used to generate multimedia files for the user.

A method of aggregating content is described. The method may include: receiving from a first device at a first location a first electronic media file associated with a user, where the first electronic media file may include a unique identifier obtained from the user at the first location, receiving from a second device at a second location a second electronic media file associated with the user, where the second electronic media file may include the unique identifier obtained from the user at the second location, associating the user with the unique identifier based at least in part on data received from the user via a third device, and generating a multimedia file for the user based at least in part on the association of the user with the unique identifier, where the multimedia file may include the first and second electronic media files.

An apparatus for aggregating content is also described. The apparatus may include a processor, memory in electronic communication with the processor, and instructions stored in the memory. The instructions may be executable by the processor to: receive from a first device at a first location a first electronic media file associated with a user, where the first electronic media file may include a unique identifier obtained from the user at the first location, receive from a second device at a second location a second electronic media file associated with the user, where the second electronic media file may include the unique identifier obtained from the user at the second location, associate the user with the unique identifier based at least in part on data received from the user via a third device, and generate a multimedia file for the user based at least in part on the association of the user with the unique identifier, where the multimedia file may include the first and second electronic media files.

A further apparatus for aggregating content is also described. The apparatus may include: means for receiving from a first device at a first location a first electronic media file associated with a user, where the first electronic media file may include a unique identifier obtained from the user at the first location, means for receiving from a second device at a second location a second electronic media file associated with the user, where the second electronic media file may include the unique identifier obtained from the user at the second location, means for associating the user with the unique identifier based at least in part on data received from the user via a third device, and means for generating a multimedia file for the user based at least in part on the association of the user with the unique identifier, where the multimedia file may include the first and second electronic media files.

A non-transitory computer-readable medium storing code for aggregating content is also described. The code may include instructions executable for: receiving from a first device at a first location a first electronic media file associated with a user, where the first electronic media file may include a unique identifier obtained from the user at the first location, receiving from a second device at a second location a second electronic media file associated with the user, where the second electronic media file may include the unique identifier obtained from the user at the second location, associating the user with the unique identifier based at least in part on data received from the user via a third device, and generating a multimedia file for the user based at least in part on the association of the user with the unique identifier, where the multimedia file may include the first and second electronic media files.

The method, apparatus, and/or computer-readable medium described above may also include features of, instructions for, and/or means for receiving a stock content media file associated with at least one of the first or second locations, where the multimedia file may include the stock content media file. Additionally or alternatively, they may include features of, instructions for, and/or means for identifying user-generated content (UGC) from the third device or from a third-party server based at least in part on metadata of the first electronic media file, metadata of the second electronic media file, the first location, or the second location, and acquiring the identified UGC from the third device or from a third-party server, where the multimedia file may include the UGC.

In some examples, identifying the UGC includes searching an application programming interface (API) for at least one of an album title, an album description, a photo title, a photo description, a date, a time, or a geographic location. In some examples, metadata of the first and second electronic media files includes the unique identifier. In still further examples, associating the user with the unique identifier may include receiving data indicative of the unique identifier from the user via the third device, and storing the unique identifier as an attribute of an account created by the user.

The method, apparatus, and/or computer-readable medium describe above may also include features of, instructions for, and/or means for receiving data indicative of a telephone number obtained from the user at the first location. Some examples may also include features of, instructions for, and/or means for transmitting a hyperlink for the multimedia file to the user utilizing the telephone number. And, in some examples, the telephone number may be linked with the unique identifier at the first location, and the metadata of the first and second electronic media files may include the telephone number.

The foregoing has outlined rather broadly the features and technical advantages of examples according to the disclosure in order that the detailed description that follows may be better understood. Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a system for dynamic content aggregation in accordance with various aspects of the present disclosure;

FIG. 2 shows a block diagram of a device for dynamic content aggregation in accordance with various aspects of the present disclosure;

FIG. 3 illustrates an example of dynamically aggregated content in accordance with various aspects of the present disclosure;

FIG. 4. illustrates an example of a process flow for dynamic content aggregation in accordance with various aspects of the present disclosure;

FIG. 5 shows a flowchart illustrating a method for dynamic content aggregation in accordance with various aspects of the present disclosure;

FIG. 6. shows a flowchart illustrating a method for dynamic content aggregation in accordance with various aspects of the present disclosure;

FIG. 7 shows a flowchart illustrating a method for dynamic content aggregation in accordance with various aspects of the present disclosure;

FIG. 8 shows a flowchart illustrating a method for dynamic content aggregation in accordance with various aspects of the present disclosure;

FIG. 9 illustrates an example of a process flow for dynamic content aggregation in accordance with various aspects of the present disclosure;

FIG. 10 shows a flowchart illustrating a method for dynamic content aggregation in accordance with various aspects of the present disclosure;

FIG. 11 shows a flowchart illustrating a method for dynamic content aggregation in accordance with various aspects of the present disclosure;

FIG. 12 shows a flowchart illustrating a method for dynamic content aggregation in accordance with various aspects of the present disclosure; and

FIG. 13 shows a flowchart illustrating a method for dynamic content aggregation in accordance with various aspects of the present disclosure.

### DETAILED DESCRIPTION

Content from disparate sources, times, and locations may be dynamically aggregated to create multimedia stories about various events. Professionally generated content (e.g., photos, videos, etc.) associated with a user (e.g., a person or group of people) may be received at a central server. The professional content may be aggregated with, for instance, stock content or user-generated content, or both, and used to generate a multimedia file for the user. The multimedia file may be referred to as a “chapter,” and may be combined with other chapters or content to tell various stories for and about a user.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

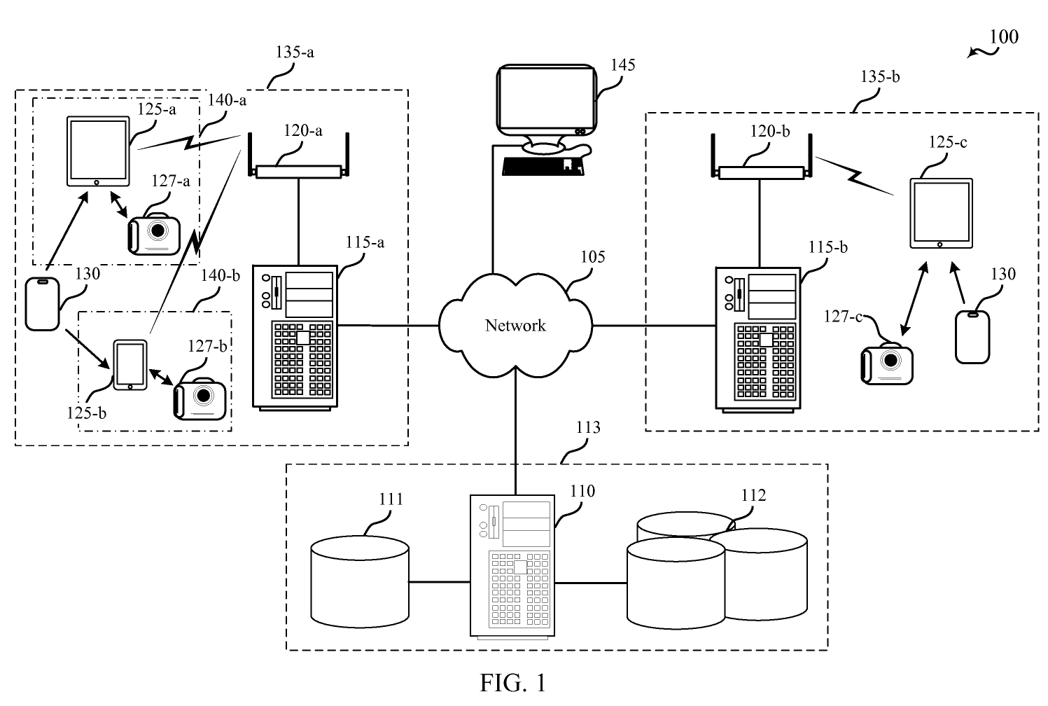

FIG. 1 illustrates an example of a system 100 for dynamic content aggregation in accordance with various aspects of the present disclosure. The system 100 may include a network 105, which may represent the internet, and through which various components of the system 100 may communicate. By way of example, the system may include a central server 110, which may be connected to, or otherwise in communication with an identification data store 111 and/or a content repository 112. Each of these devices may be located at a central hosting location 113. In some cases, the system 100 includes venue servers 115, venue access points 120, venue access terminals 125, digital media devices 127, and/or identification devices 130. Each of these devices may be associated with venues 135 and/or sub-venues 140. The system 100 may further include a user terminal 145.

In some examples, one or more unique identifiers are entered and/or created at the central server 110 and stored at the identification data store 111. In other cases, unique identifiers may be created outside the system 100 and may remain unknown to the system until linked with content, as discussed below. These unique identifiers may be or be represented by code, numbers, alpha-numeric descriptions, and/or other similarly unique representations. In some cases, each unique identifier is tied to an identification device 130. For example, an identification device 130 may be a card bearing the unique identifier as number and/or in a machine-readable format—e.g., magnetic strip, barcode, matrix barcode, such as a Quick Response (QR) code, etc. In other cases, the identification device 130 is a radio frequency identification (RFID) tag containing electronically coded information corresponding to the unique identifier. In still other examples, the identification device 130 is a mobile phone and the unique identifier is factory-set electronic serial number (ESN).

The venue terminals 125 may be configured to obtain a unique identifier from the identification devices 130. For example, a venue terminal 125 may be a tablet computer, a mobile phone, a smart phone, a laptop, or similar computing device, which may be equipped with a camera (or other optical device) capable of reading a matrix barcode, such as a QR code. The identification device 130 may bear a matrix barcode corresponding to a unique identifier. Thus, the venue terminals 125 may be manipulated to scan the matrix barcode of identification devices 130 and obtain the unique identifier. Those skilled in the art will recognize that the other combinations of information storage and transfer may be suitable for relaying a unique identifier from an identification device 130 to a venue terminal 125. For instance, RFID technology (e.g., Near Field Communication (NFC)) may be employed to communicate the unique identifier. Additionally or alternatively, biometric information, including fingerprints, palmprints, facial features, irises, body geometry, voice or speech patterns, and the like, may be employed as a unique identifier or to communicate a unique identifier.

Once a venue terminal 125 has obtained a unique identifier, it may store the unique identifier locally (e.g., in local memory). In some cases, a venue terminal 125 is an aspect of a digital media device 127, such as a camera or video camera. Or, a venue terminal 125 may also be a digital media device capable of capturing digital content. In other words, a single device may perform the functions of both a venue terminal 125 and a digital media device 127. For example, a camera may be equipped with RFID technology and may be used to obtain a unique identifier from an identification device 130.

In some examples, content (e.g., a photo) captured by a digital media device 127 may be transferred (e.g., wirelessly or through a wired connection) to the venue terminals 125 and linked with a locally stored unique identifier. In other cases, the unique identifier is stored at the digital media device 127, and the unique identifier may be linked with captured content. In either case, an electronic media file may be created with the unique identifier; and each electronic media file created by a digital media device 127 may be created with the unique identifier until a new or different unique identifier is stored at the digital media device 127.

For example, an electronic media file may be created with the unique identifier as an aspect of the metadata of the file. In some cases, a digital media device 127 creates an electronic media file (e.g., JPEG, MPEG, etc.) with metadata including the unique identifier, relative location (e.g., venue or sub-venue), geographic location where the file was created, date and time the file was created, and the like. In other examples, a file captured by a digital media device 127 may be transmitted to a venue terminal 125, where an electronic media file is created with the unique identifier. That is, a venue terminal 125 may append a unique identifier to a file captured by another device, e.g., as metadata. The captured content may thus be linked to a venue and/or sub-venue and to a unique identifier by way of the metadata. In other words, the metadata of an electronic media file may indicate information about files created, and it may include a unique identifier associated with a person or group. In this way, linked venue content may indicate who (or what) is the subject of the content and where the content was captured.

Once a venue terminal 125 and/or a digital media device 127 links digital content, which may be referred to as a file and/or venue content, to a unique identifier, the venue terminal 125 may upload the linked venue content and unique identifier (e.g., an electronic media file) to a venue server 115. The venue terminal 125 may upload content, such as electronic media files, to the venue server 115 via a venue access point 120. Then, according to some examples, content uploaded to the venue server 115 is uploaded to the central server 110 via the network 105. Content received at the central server 110 may be stored at the content repository 112.

At the central server 110, multiple items of venue content may be aggregated—e.g., collected and/or compiled together. For example, several photos or videos having a common unique identifier may be aggregated. In some embodiments, the aggregated content is used to create a multimedia file, or chapter of content, associated with a particular venue 135 or sub-venue 140. Multiple chapters—e.g., multiple compilations of photos, videos, etc., from various venues and/or sub-venues—may be combined to create a unique storybook or story.

A user of identification device 130 may be associated with the captured digital content via data received from the user at the central server 110. For example, a user may access, via the user terminal 145 and the network 105, the central server 110 through a web-based portal. In some cases, the user has a code, number, or alpha-numeric sequence, etc., that is, or corresponds to, a unique identifier of an identification device 130. The user may access a web-based portal to the central server 110, and may be prompted to enter the unique identifier. In some examples, the user may key in the code, number, or alpha-numeric sequence, etc. corresponding to the unique identifier of an identification device 130. In other examples, the user may scan or use an RFID connection to input the unique identifier. The unique identifier may then be stored as an attribute of a user account, which the user may maintain on the central server 110. The central server 110, or aspects of it, may thus associate the user with the unique identifier.

In some examples, a telephone number, such as a mobile phone number, may be used to communicate with and/or associate content to users within the system 100. For example, a telephone number may be obtained from a user at a venue 135 or sub-venue 140. A venue terminal 125 may be used to capture the telephone number through manual entry, text message, or the like, and the venue terminal 125 may upload the telephone number, or a file containing the telephone number, to the central server 110 via a venue access point 120, a venue server 115, and/or the network 105.

In some cases, a telephone number is linked with a unique identifier. For instance, a user's unique identifier and telephone number may be stored as related data and/or attributes at a venue terminal 125 or a digital media device 127. Additionally or alternatively, electronic media files may be created with a telephone number as an aspect of the file—e.g., as described above. The central server 110 may transmit, or cause to be transmitted, data (e.g., SMS messages) to a user utilizing a telephone number. For instance, a hyperlink for multimedia files (e.g., chapters) may be transmitted to a user utilizing the telephone number.

By way of illustration, the system 100 may be employed to create a unique storybook for a Hawaiian vacationer. For example, a unique identifier, which may be a number, may be created at the central server 110 and stored in the identification data store 111. Alternatively, the unique identifier may be created elsewhere and be unknown to the modules of the central server 110. In some examples, the unique identifier is translated to, or represented by a QR code, and printed on a card, which may be an identification device 130. The vacationer may be given the identification device 130 by, for example, the resort where he or she is staying on Maui. The resort may be a venue 135-a.

During the vacationer's stay, he or she may attend a luau, which may be a sub-venue 140-a of the resort. At the luau, a professional photographer may be mingling with and capturing digital photos of the guests, including the vacationer. For example, the photographer may approach the vacationer, scan the QR code of the vacationer's identification device 130 with a venue terminal 125-a (e.g., with a tablet computer or barcode reader). The photographer may then snap one or more photos of the vacationer using the digital media device 127-a, which are transferred as digital files to the venue terminal 125-a and linked with the vacationer's unique identifier—e.g., the unique identifier may be appended as metadata of the digital files from digital media device 127-b. The photos also may be linked with the luau sub-venue 140, for example, using geo-location metadata. According to some examples, the photographer then uploads the digital photos (e.g., electronic media files) of the vacationer, which are linked to the vacationer's unique identification number, to the venue server 115-a of the venue 135-a (e.g., the resort). In some cases, this upload is effected by connecting the venue access terminal 125-a to a venue access point 120-a, which may be a wireless local area network (WLAN) router.

The vacationer may also attend, for example, a snorkeling trip, which may be a sub-venue 140-b of the resort venue 135-a. As with the luau, a professional photographer on the snorkeling trip may scan the vacationer's identification device 130, capture photos and/or video of the vacationer with digital media device 127-b, which may be linked to the captured photo/video files with a venue access terminal 125-b (e.g., a smart phone). The snorkeling photographer may then upload the content, which was linked to the unique identifier, to the venue server 115-a via a venue access point 120-a.

The vacationer may subsequently go on a helicopter tour of the island of Maui, which may be another venue 135-b. According to some examples, the helicopter pilot may scan the vacationer's identification device 130 with venue terminal 125-c, and the pilot may take photos of the vacationer with digital media device 127-c, which are then linked with the vacationer's unique identifier through venue access terminal 125-c. The helicopter pilot may upload the linked venue content (e.g., helicopter tour photos) via a venue access point 120-b, which may be a WLAN router connected to the helicopter tour's venue server 115-b (e.g., the helicopter tour's business computer).

Then, in some cases, photos and videos of the vacationer (e.g., electronic media files) are uploaded from the venue servers 115 to the central server 110. The central server 110 may, in turn, store the venue content to the content repository 112. When the vacationer returns home she may, for example, access a web-based portal on the central server 110 via a user terminal 145 (e.g., the vacationer's home computer). The portal may prompt the vacationer to create an account, which may include prompting the vacationer to enter, among other things, her unique identifier or identifiers. The vacationer may also be prompted to enter other data, including name, address, telephone numbers, billing and payment information, social media account information, and the like.

In some examples, once the vacationer enters her unique identifier, the stored venue content linked to her unique identifier is then associated with vacationer as described above—e.g., the unique identifier may be stored as an attribute of her account and all electronic media files having the same unique identifier may be associated with her account. The central server 110 may also be equipped with software that aggregates each item of venue content linked with a common unique identifier (e.g., each photo and/or video linked with the vacationer's unique identifier). The central server 110, or a module of the server, may generate a multimedia file for the vacationer based on the association of the vacationer with the unique identifier. In some cases, the central server 110 creates a storybook, which includes chapters; in turn, the chapters each include venue content from a specific venue or sub-venue. The multimedia file may be or include a chapter, chapters, a storybook, and/or storybooks. For example, the vacationer, upon accessing the web-based portal, may be presented with a storybook that includes chapters depicting her Hawaiian vacation: there may be a chapter with content from the luau, one with content from the snorkeling trip, and another with content from the helicopter tour. As discussed below, the storybook (e.g., multimedia file) may also include stock content, user-generated content, and/or third-party content related to or associated with the vacationer's Hawaiian vacation.

Those skilled in the art will recognize that the tools and techniques described herein have broad applicability beyond the tourism industry. For example, a story may be based around a child's years in school—kindergarten through high school graduation. In such cases, chapters may be based around each grade level, and content may include professional school portraits of a child, stock content from the child's school, and third party content from extracurricular activities (e.g., sports, band, drama, or chess club). In other examples, stories may include a user's athletic competitions (e.g., marathons, golf tournaments, and/or softball games). In still further examples, stories and/or chapters may be based around other memorable life events, including weddings, birthdays, and religious celebrations.

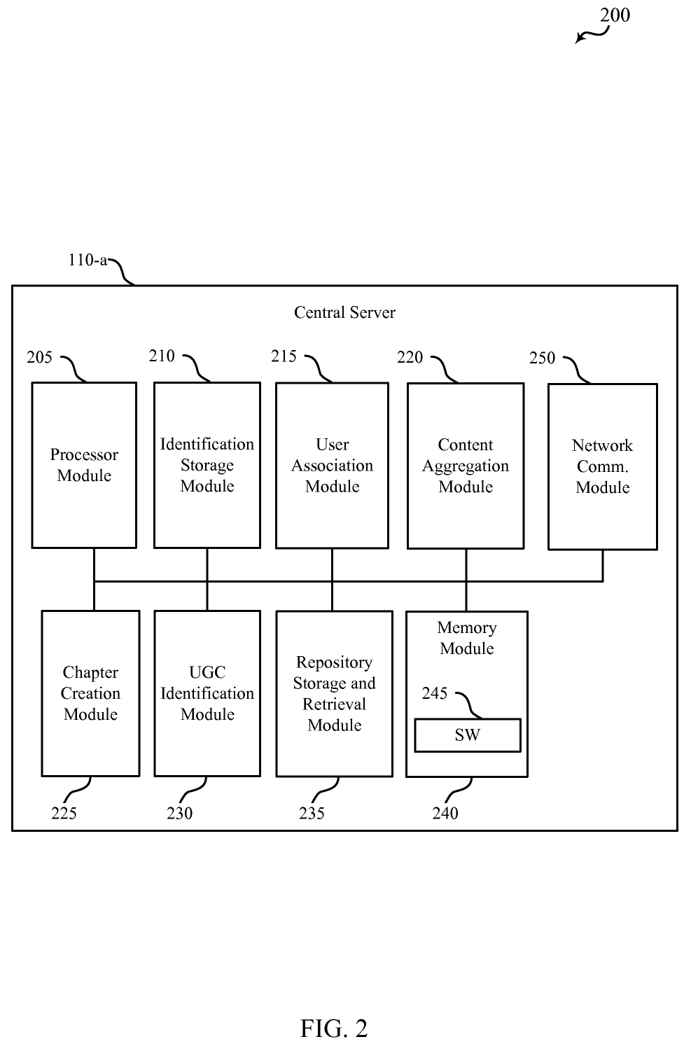

Turning now to FIG. 2, a block diagram of a device 200 for dynamic content aggregation in accordance with various aspects of the present disclosure is shown. The device 200 may be a central server 110-a, which may be an example of the central server 110 described with reference to FIG. 1. The device 200 may include a processor module 205, an identification storage module 210, a user association module 215, a content aggregation module 220, a chapter creation module 225, a user-generated content (UGC) identification module 230, a repository storage and retrieval module 235, a memory module 240, and/or a network communication module 250. Each of the modules may be in communication with one another; and the modules may perform substantially the same functions described with reference to the central server 110 of FIG. 1.

In some embodiments, the components of the device 200 are, individually or collectively, implemented with one or more application-specific integrated circuits (ASICs) adapted to perform some or all of the applicable functions in hardware. Alternatively, the functions may be performed by one or more processing units (or cores), on one or more integrated circuits. In other embodiments, other types of integrated circuits are used (e.g., Structured/Platform ASICs, field-programmable gate arrays (FPGAs), and other Semi-Custom integrated circuits (ICs)), which may be programmed in any manner known in the art. The functions of each unit also may be wholly or partially implemented with instructions embodied in a memory, formatted to be executed by one or more general or application-specific processors.

By way of example, the identification storage module 210 may create one or more unique identifiers, and it may store those identifiers or direct them to be stored in an external data store, e.g., the identification data store 111 described with reference to FIG. 1. In some cases, existing unique identifiers (e.g., factory-set cellular phone ESNs) may be entered into the identification storage module 210, and they may be stored locally or remotely.

The content aggregation module 220 may aggregate disparate venue content linked to a common unique identifier. For example, the content aggregation module 220 may aggregate electronic media files created at and received from different locations, when the electronic media files include common unique identifiers. The aggregated venue content may be used, for example by the chapter creation module 225, to create chapters (e.g., multimedia file). As discussed above, a chapter may be a compilation of venue content, such as photos, which each may be related to a common venue and/or sub-venue. That is, in some examples, a chapter is a multimedia file that includes electronic media files having a common unique identifier and common location information, such as metadata.

Additionally or alternatively, the chapter creation module 225 may incorporate venue-specific (or sub-venue-specific) stock content into a chapter. Stock content, as used here, means content that is related to a venue or sub-venue, but which is generic in nature and may be used in a number of chapters and/or stories for different users. Stock content may be proprietary content of a venue and/or sub-venue. For example, in a chapter related to a panda exhibit at a city zoo, stock content may include: maps of panda habitat, generic photos of pandas, photos of pandas at the particular zoo, graphics related to the exhibit, explanatory text about pandas, or the like. Stock content may help tell the story of a visitor's vacation, holiday, trip, and/or excursion, but the stock content may not include visitor-specific content, such as images of the visitor.

Stock content, or a stock content media file (e.g., JPEG, MPEG, PDF, MP3, MP4, MOV, text file, etc.) may be received at the central server 110-a from, for example, a venue server 115 (FIG. 1) over the internet. Stock content may include identifying information (e.g., metadata), which may indicate a geographic or relative location, time of day, season, or the like for which the stock content is relevant. The chapter creation module 225 may identify stock content based on such identifying information, and, in conjunction with other modules of the central server 110-a, may create a chapter—e.g., generate a multimedia file—that includes a stock content media file having identifying information relevant to a venue content associated with a user. For instance, the chapter creation module 225 may generate a multimedia file that includes several electronic media files associated with a user, and which may include stock content having one or more aspects of metadata (e.g., location) in common with an electronic media file associated with the user.

In some cases, the chapter creation module 225 also incorporates venue-based social media content into one or more chapters. For example, the chapter creation module 225 may access a social media feed (e.g., Facebook, Twitter, Instagram, and/or Pinterest), and it may incorporate venue- and/or sub-venue-specific social media content into a chapter (e.g., a multimedia file). The chapter creation module 225 may utilize aspects of metadata from electronic media files associated with a user to identify relevant venue- and/or sub-venue-specific social media content. For instance, the chapter creation module 225 may identify location, time, and/or date information that corresponds to metadata of the electronic media files. By way of illustration, the chapter creation module 225 may access a Twitter feed related to a sub-venue (e.g., a luau), capture Tweets from the sub-venue operators, and incorporates them into a luau chapter. In such an example, the Tweets may reflect specific details of a vacationer's luau experience—e.g., attendance, performers, weather conditions, etc.

The user association module 215 may facilitate association of venue content (e.g., electronic media files) with a particular user. For example, the user association module 215 may host a web-based portal through which a user may access the terminal In some cases, a user accesses the central server 110-a via a user terminal (e.g., the user terminal 145 described with reference to FIG. 1), which may be a user's home computer, notebook computer, tablet, smartphone, etc. The user association module 215 may prompt the user to create a user account. A user account may be based on other web-based accounts; for example, a user may create an account using his Facebook, Google, Gmail, Twitter, etc., accounts. Or, a user may create a new account specific to the central server 110-a and its associated host. According to some examples, a user will be prompted to enter a unique identification number that corresponds to, for example, a user's identification device 130. Upon creating an account, the user association module 215 may associate stored content to the user based on the unique identifier. Additionally or alternatively, a user with an existing account may add unique identifiers, which may allow additional content to be associated with the user.

In some cases, user accounts may be shared by multiple users and/or may provide for multiple access by different users. For instance, family members may share a common account, for which each member of the family may access some or all functionality of the account. In other examples, one user may utilize another user's account as the basis for creating an account. In still other examples, certain content (e.g., photos, videos, etc.) may be shared among users of the same or different accounts. For instance, users having separate accounts may share certain content that is accessible by either account.

By way of example, the user association module 215 may be configured to identify linked venue content with the unique identifier and to associate the user using the unique identifier. In some cases, content associated with the user (e.g., electronic media files with the unique identifier) has previously been aggregated by the content aggregation module 220, and chapters have been created (using aggregated content, stock content, and/or venue-based social media content) by the chapter creation module 225, so the user is able to view a prepared story of chapters once he creates an account with the user association module 215. In other words, upon user login and/or association with the unique identifier, a multimedia file may have already been generated for the user's use and/or viewing. In some cases, the repository storage and retrieval module 235 displays or otherwise conveys to the user a stream of content (e.g., a photo stream) associated with the user. For example, the content storage and retrieval module 235 may, in conjunction with other modules of the central server 110-a, transmit to the user a hyperlink to a multimedia file by utilizing the user's telephone number, as described above.

In some cases, the repository storage and retrieval module 235 stores and/or archives content locally; or it may facilitate content storage at a location external to the central server 110-a. For example, the repository storage and retrieval module 235 may facilitate content storage at a repository, such as the content repository 112 described with reference to FIG. 1. In some cases, the repository storage and retrieval module 235 causes linked venue content to be stored. For example, electronic media files received at the central server 110-a from venue terminals 125 (FIG. 1) may be stored at external data stores by the repository storage and retrieval module. Additionally or alternatively, the repository storage and retrieval module 235 may cause created chapters and/or stories (e.g., compilations of chapters) to be stored. The repository storage and retrieval module 235 may also retrieve stored content, chapters, and/or stories from a content repository. For example, at the request of a user, the repository storage and retrieval module 235 may retrieve archived chapters or stories associated with the user. That is, the repository storage and retrieval module 235 may store and/or retrieve multimedia files generated for a user. In this way, a user may maintain a virtual bookshelf of stories at a content repository; and the user may access the virtual bookshelf using his account and by logging into the central server 110-a via the user association module 215.

Additionally or alternatively, the repository storage and retrieve module 235 may facilitate compilations of chapters made up of content that is temporally separate. For example, a story related to skiing may be made from content associated with a user's many different ski vacations that occurred over a many years. In other examples, a user may create a story based on visits to a common venue over the course of a year. For instance, a story may be created for a member who has an annual pass to a city zoo, and the story may include content from each of the member's trips to the zoo throughout the year. In another example, a baseball season ticket holder may create, or have created for him, a story for each game of the season that he attended. Thus, in conjunction with the user association module 215 and the chapter creation module 225, a the repository storage and retrieval module 235 may identify archived electronic media files and/or archived multimedia files according to various aspects of metadata; and the various modules may aggregate files accordingly and/or according to user input.

In some cases, the repository storage and retrieval module 235 may facilitate a user purchasing, downloading, and/or sharing content associated with the user (e.g., electronic media files and/or multimedia files). For example, after accessing associated content, a user may be prompted with an option to purchase digital or print versions of content, chapters, and/or stories associated with the user. The user may further be prompted with options to post the content, chapters, and/or stories to the user's social media sites (e.g., Facebook, Twitter, Instagram, and Pinterest). If a user purchases content, revenue from the purchase may be shared according the originator and/or contributor of the content. For instance, in the example of a helicopter tour venue as described above with reference to FIG. 1, the tour operator may be compensated a pro rata share of the purchase price if the user buys a story with a helicopter tour chapter—e.g., a multimedia file that includes one or more electronic media file received from the helicopter tour venue. This may be the case if the helicopter tour is operated by a company different from, and independent of the resort where the vacationer is staying. Content may be referred to as third-party content to distinguish it from venue content and/or stock content.

In some cases, a user account may be used to create a social-media profile. A user may allow others to view content associated with the user. For example, one user may be able to “follow” a second user and peruse the second user's various stories. With the social media profile, the user may be able to get notifications about content (e.g., multimedia files), comment on other's content and receive comments, purchase content, and the like.

The UGC identification module 230 may facilitate capturing (e.g., scraping) user-generated content to which the user has given access permissions. For example, during a process of creating an account, a user may be prompted with an option to allow aspects of the central server 110-a to access the user's social media accounts. The UGC identification module 230 may scan, crawl, and/or scrape the user's social media accounts, and thereby identify UGC for integration into a chapter and/or story of the user. The UGC identification module 230 may, for instance, recognize certain venue content that has been linked to a unique identifier entered by, and thus associated with, a user. That is, the UGC identification module 230, in conjunction with the user association module 215 and/or the content aggregation module 220, may recognize that one or more electronic media files have a common unique identifier associated with a user, and the UGC identification module may identify location information (or other metadata) included in those electronic media files.

Based on this “knowledge” of the venue (or sub-venue), the UGC identification module 230 may initiate a search of UGC. In some cases, the UGC identification module 230 identifies UGC by searching an application programming interface (API) of a user's social media for certain keywords. The UGC identification module 230 may, for instance, initiate a search of a user's Facebook API for photos by searching for photo album title, album description, photo title, photo description, date, time, and/or geographic location (e.g., GPS data). Upon identifying UGC based on a correspondence between information from the API and electronic media file metadata, the chapter creation module 225 may acquire the UGC by downloading it from a third-party server (e.g., Facebook). Chapters or stories (e.g., multimedia files) may thus be generated with the acquired UGC.

By way of illustration, a user may create an account via the user association module 215, and she may access her associated content from a recent ski vacation. The user may be prompted to grant the central server 110-a permissions to the user's Instagram account; and the user may grant permission. The UGC identification module 230 may search the user's Instragram account API for UGC with date, time, and/or geographic data that corresponds to venue content (e.g., electronic multimedia files) associated with the user. The UGC identification module 230 may further search for specific album and/or photo descriptions indicative of the user's ski vacation. If a user is accessing venue content from Vail, for example, the UGC identification module 230 may search for “Vail” in a description of a photo with a date, time, and/or GPS stamp that corresponds to the user's ski vacation at Vail.

The memory module 240 may include random access memory (RAM) or read-only memory (ROM), or both. In some embodiments, the memory module 240 stores computer-readable, computer-executable software (SW) code 245 containing instructions that are configurable to, when executed, cause the processor module 205 to perform various functions described herein for operating the central server 110-a, and its various modules. In other embodiments, the software code 245 is not directly executable by the processor module 205, but it may be configured to cause a computer, for example, when compiled and executed, to perform functions described herein with reference to each of the modules of the central server 110-a.

The network communication module 250 may facilitate bi-directional communication with a network 105 (FIG. 1). The network communication module 250 may include a modem that may modulate packets and transmit them to the network 105, and that may receive packets from the network and demodulate the received packets. In some examples, the network communications module 250 may receive data indicative of a user's telephone number, such as a text message or a file from a venue terminal 125 (FIG. 1). Additionally or alternatively, the network communications module 250 may transmit a link, such as a hyperlink, for a multimedia file to the user utilizing the telephone number.

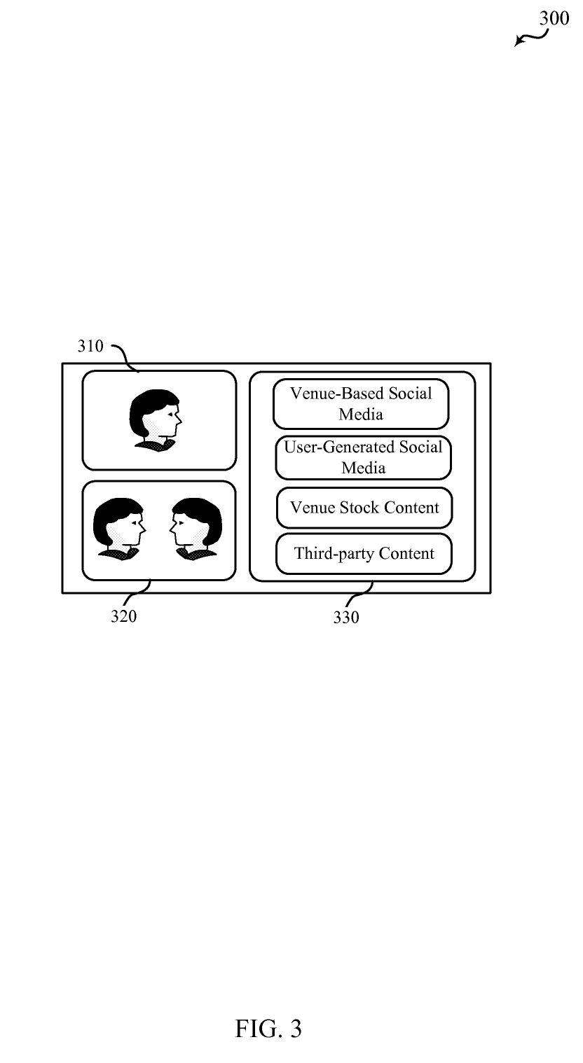

Next, referring to FIG. 3, an example of dynamically aggregated content 300 is illustrated in accordance with various aspects of the present disclosure. The content 300 may be an example of a chapter created by the chapter creation module 225, and may be referred to as a multimedia file. The chapter 305 may include aggregated items of venue content 310 and 320, which may be photos and/or video of a user or users, and with may be referred to as electronic media files. The chapter 305 may also include other content 330, which may be venue-based social media, UGC (e.g., user-generated social media), and/or stock content. In some cases, the chapter 305 also includes some additional third-party content—e.g., third-party professional photos of a particular venue that the user and/or the chapter creation module 225 has imported and incorporated.

As discussed, a chapter may be defined by content related to a venue and/or a sub-venue; and chapters may be compiled to create stories. Stories and chapters may be further defined by one or more increments of time. For example, a story about a visit to a zoo may be defined by a single day, which represents the time for that visit. In other cases, such as a ski vacation, a story may be defined by several days or a week. In another example, such as an outing to a baseball game, the story may be defined by the length of the game. In yet another example, such as a child's elementary school experience, a story may be defined as the time the child was in elementary school, with each chapter comprising content from a single school year. In other words, the timeframe from which content is gathered (e.g., aggregated) to be incorporated into a particular chapter and/or story may be specific to a type of life experience (e.g., vacation, holiday, activity, adventure, outing, and/or time period). The various modules of the central server 110-a (FIG. 2), for instance, may identify common values of metadata for various electronic media files (e.g., location, date, time, etc.), and it utilize these common values to aggregate the electronic media files and/or to generate a multimedia file.

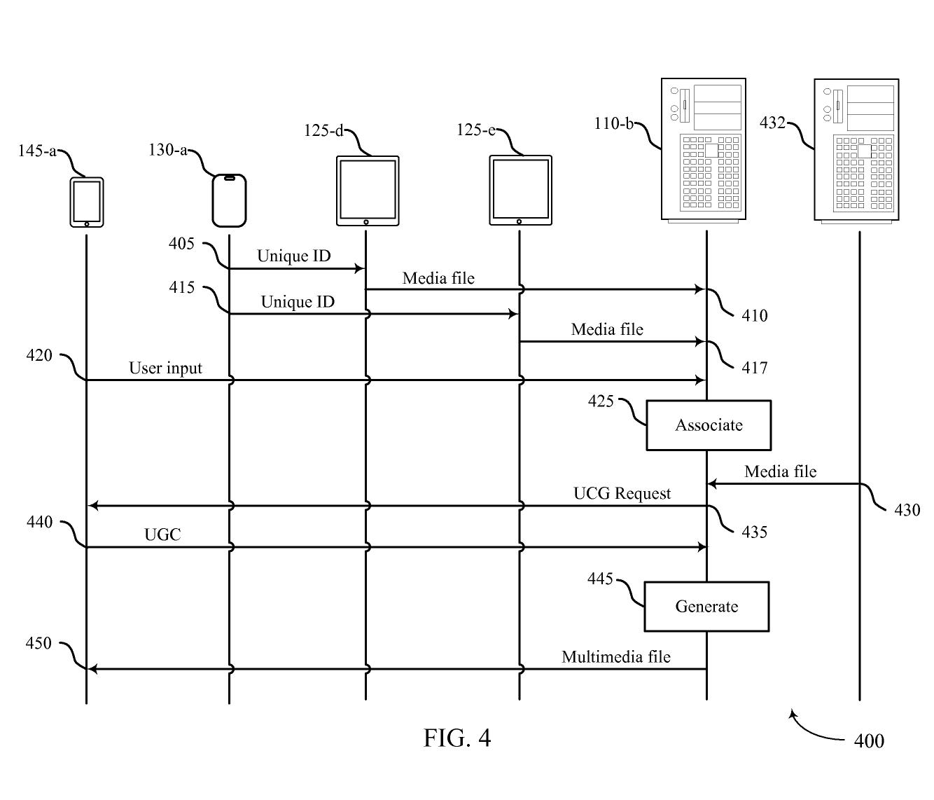

Next, FIG. 4 illustrates an example of a process flow 400 for dynamic content aggregation in accordance with various aspects of the present disclosure. The process flow 400 may include a central server 110-b, venue terminals 125-d and 125-e, an identification device 130-a, and a user terminal 145-a, each of which may be examples of the corresponding components of the system 100 and 200 of FIGS. 1 and 2. The process flow may also include a server 432, which, in some cases, may be an example of a venue server 115 of FIG. 1.

The identification device 130-a may include a unique identifier, which may be obtained via message 405 by the venue terminal 125-d. The venue terminal 125-d may be located at a first venue, and it may obtain the unique identifier from the identification device 130-a, and thus a user, at the first venue. The venue terminal 125-d may obtain the unique identifier by scanning a barcode, receiving a wireless signal, or the like, as described above. The central server 110-b may receive and electronic media file, which may be associated with the user, in message 410 from the venue terminal 125-d.

The identification device's 130-a unique identifier may be obtained by the venue terminal 125-e via message 415. The venue terminal 125-e may be located at a second venue, and it may obtain the unique identifier from the identification device 130-a, and thus the user, at the second venue. The venue terminal 125-e may obtain the unique identifier by scanning a barcode, receiving a wireless signal, or the like, as described above. The central server 110-b may receive an electronic media file, which may be associated with the user, in message 417 from the venue terminal 125-e.

A user may access the central server 110-b through a web-based portal via user terminal 145-a. The user may access and/or create a user account, and the user may, in message 420, transmit a user input, which may include the unique identifier of the identification device 130-a, to the central server 110-b. That is, the central server 110-b may receive data from the user via the user terminal 145-a, and the data may include the unique identifier. The central sever 110-b may thus associate the user and the unique identifier at block 425 based, at least in part, on the data received from the user.

In some examples, the central server 110-b may receive, via message 430, one or more stock content media files associated with a venue or venues. For example, the stock content media files may be associated with the venues where venue terminals 125-d and/or 125-e are located.

Additionally or alternatively, the central server 110-b may, via message 435, request access to UCG, which may be located on user terminal 145-a and/or at social media accounts of the user. The user may grant access, and the central server 110-b may, in turn, identify UGC from the user terminal 145-a or a server of the user's social media account. The central server 110-b may, via message 440, acquire the identified UGC from the user.

At block 445, the central server 110-b may generate a multimedia file for the user. The multimedia file may be based, to some extent, on the association between the user and the unique identifier; and the multimedia file may include electronic media files associated with the user, one or more stock content media files, and/or UGC. The central server 110-b may then transmit, via message 450, the multimedia file to the user. Additionally or alternatively, the user may access the multimedia file on the central server 110-b via the web-based portal.

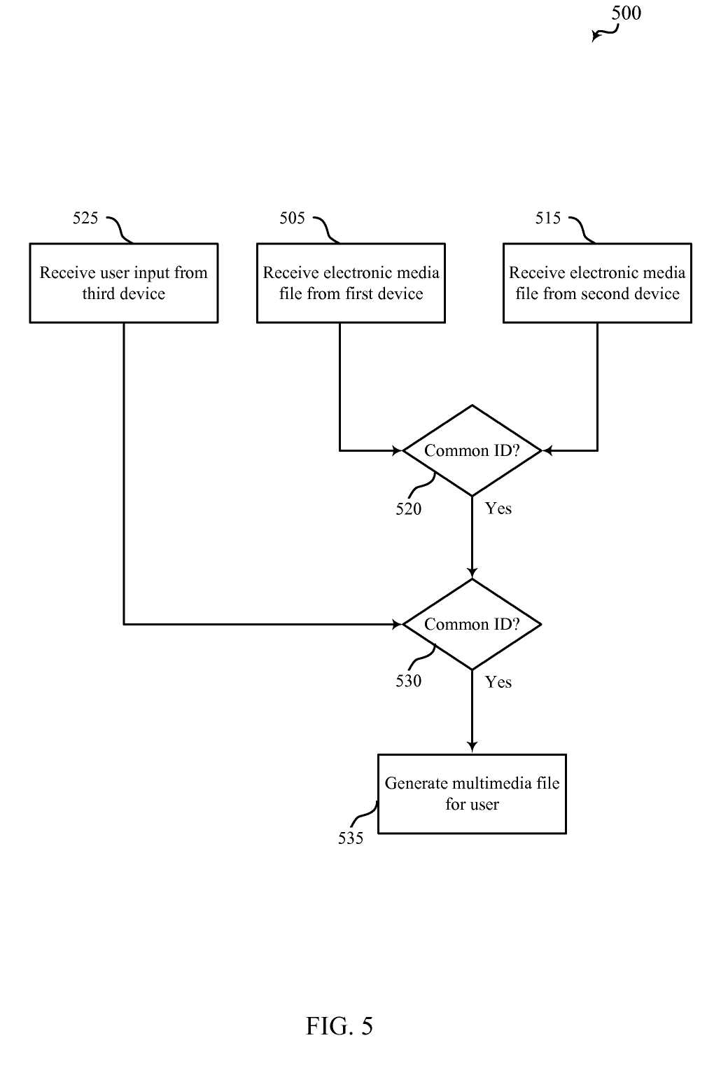

FIG. 5 shows a flowchart illustrating a method 500 for dynamic content aggregation in accordance with various aspects of the present disclosure. The method 500 may be implemented by, for example, a central server 110 or its components, as described above with reference to FIGS. 1, 2, and 4. In some examples, the central server 110 may execute a set of codes to control the functional elements of the central server 110 to perform the functions described below. Additionally or alternatively, the central server 110 may perform aspects of the functions described below using special-purpose hardware.

At block 505, the central server 110 may receive an electronic media file from a first device at a first location. At block 515, the central server 110 may receive an electronic media file from a device at a second device at a second location. Then, at block 520, the central server 110 may determine whether the electronic media files include a common, unique identifier. If they do, the central server 110 may aggregate the electronic media files.

At block 525, the central server 110 may receive a user input from a third device, such as a user terminal 145 (FIGS. 1, 2, and 4), and the user input may include a unique identifier. At block 530, the central server 110 may determine whether a unique identifier from the user corresponds with a unique identifier of received electronic media files. If so, the central server 110 may, at block 535, generate a multimedia file for the user, and the multimedia file may include the received electronic media files having a unique identifier that corresponds to (e.g., is the same as) a unique identifier input by the user.

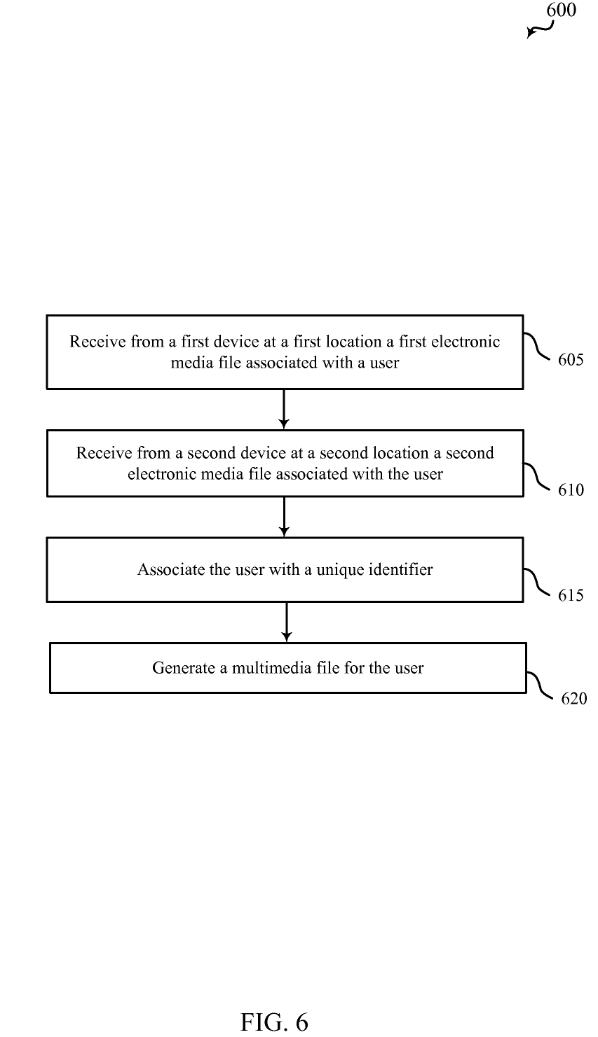

FIG. 6 shows a flowchart illustrating a method for dynamic content aggregation in accordance with various aspects of the present disclosure. The method 600 may be implemented by, for example, a central server 110 or its components, as described above with reference to FIGS. 1, 2, and 4. In some examples, the central server 110 may execute a set of codes to control the functional elements of the central server 110 to perform the functions described below. Additionally or alternatively, the central server 110 may perform aspects of the functions described below using special-purpose hardware. The method 600 may be an example of the method 500.

At block 605, the method may include receiving from a first device at a first location a first media file associate with a user. The first electronic media file may include a unique identifier obtained from the user at the first location. The operations of block 605 are, in some examples, performed by the content aggregation module 220, as described above with reference to FIG. 2

At block 610, the method may include receiving from a second device at a second location a second electronic media file associated with the user. The second electronic media file may include the unique identifier obtained from the user at the second location. The operations of block 610 are, in some examples, performed by the content aggregation module 220, as described above with reference to FIG. 2

At block 615, the method may include associating the user with a unique identifier, which may be based at least in part on data received from the user via a third device. The operations of block 615 are, in some examples, performed by the user associate module 215, as described above with reference to FIG. 2.

At block 620, the method may involve generating a multimedia file for the user, which may be based at least in part on the associate of the user with the unique identifier. The multimedia file may include the first and second electronic media files having the unique identifier. The operations of block 620 are, in some examples, performed by the chapter creation module 225, as described with reference to FIG. 2. The content 300 described with reference to FIG. 3 may be an example of a multimedia file generated in the method 600.

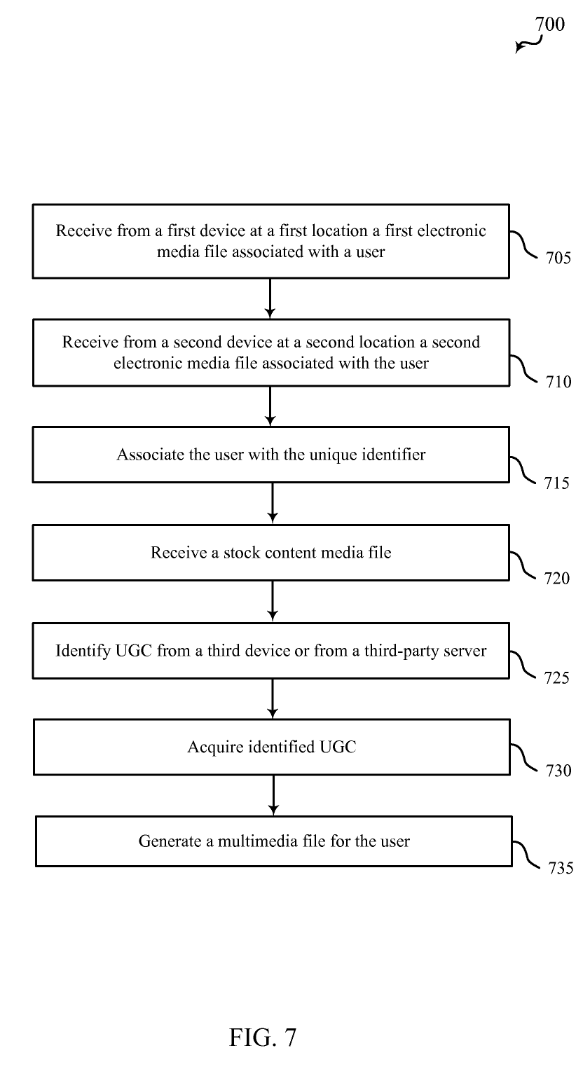

FIG. 7 shows a flowchart illustrating a method for dynamic content aggregation in accordance with various aspects of the present disclosure. The method 700 may be implemented by, for example, a central server 110 or its components, as described above with reference to FIGS. 1, 2, and 4. In some examples, the central server 110 may execute a set of codes to control the functional elements of the central server 110 to perform the functions described below. Additionally or alternatively, the central server 110 may perform aspects of the functions described below using special-purpose hardware. The method 700 may be an example of the methods 500 and/or 600.

At block 705, the method may include receiving from a first device at a first location a first media file associate with a user. The first electronic media file may include a unique identifier obtained from the user at the first location. The operations of block 705 are, in some examples, performed by the content aggregation module 220, as described above with reference to FIG. 2

At block 710, the method may include receiving from a second device at a second location a second electronic media file associated with the user. The second electronic media file may include the unique identifier obtained from the user at the second location. The operations of block 710 are, in some examples, performed by the content aggregation module 220, as described above with reference to FIG. 2

At block 715, the method may include associating the user with a unique identifier, which may be based at least in part on data received from the user via a third device. The operations of block 715 are, in some examples, performed by the user associate module 215, as described above with reference to FIG. 2.

At block 720, the method may include receiving a stock content media file, which may be associated with at least one of the first or second locations. For example, the stock content media file may have location metadata that corresponds with location metadata of the first and/or second electronic media file. The operations of block 720 are, in some examples, performed by the network communication module 250 and/or the chapter creation module 225.

At block 725, the method may include identifying UGC from a third device or from a third-party server, which may be based at least in part on metadata of the first electronic media file, metadata of the second electronic media file, the first location, or the second location. The operations of block 725 are, in some examples, performed by the UGC identification module 230, as described above with reference to FIG. 2.

At block 730, the method may include acquiring identified UGC from the third device and/or from the third-party server. The operations of block 730 are, in some examples, performed by the UGC identification module 230, as described above with reference to FIG. 2.

At block 735, the method may involve generating a multimedia file for the user, which may be based at least in part on the associate of the user with the unique identifier. The multimedia file may include the first and second electronic media files having the unique identifier, the stock content file, and/or the UGC. The operations of block 735 are, in some examples, performed by the chapter creation module 225, as described with reference to FIG. 2. The content 300 described with reference to FIG. 3 may be an example of a multimedia file generated in the method 700.

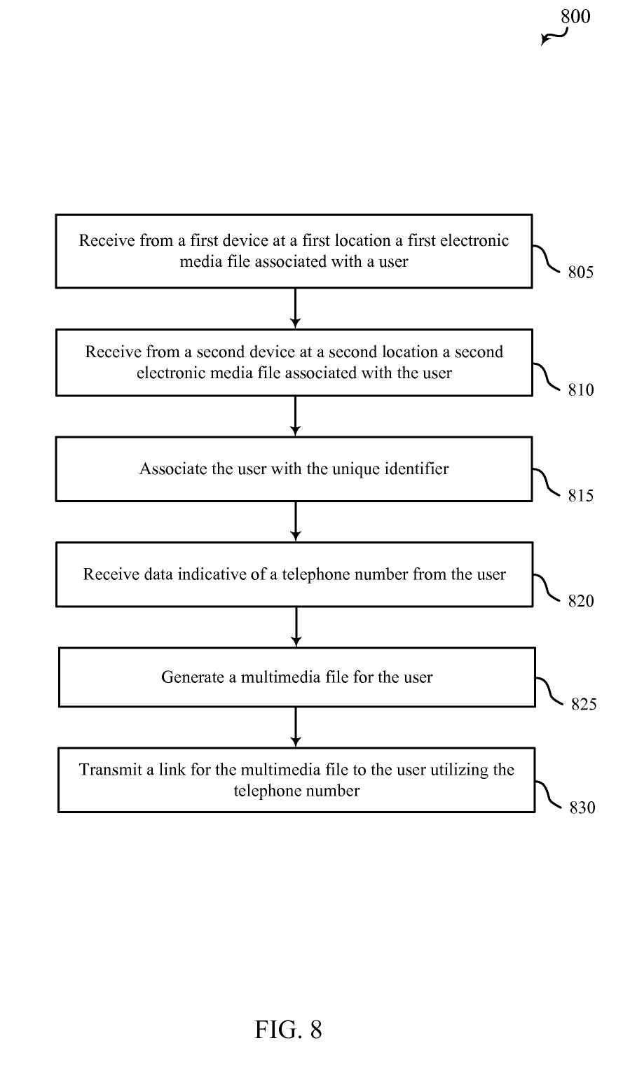

FIG. 8 shows a flowchart illustrating a method for dynamic content aggregation in accordance with various aspects of the present disclosure. The method 800 may be implemented by, for example, a central server 110 or its components, as described above with reference to FIGS. 1, 2, and 4. In some examples, the central server 110 may execute a set of codes to control the functional elements of the central server 110 to perform the functions described below. Additionally or alternatively, the central server 110 may perform aspects of the functions described below using special-purpose hardware. The method 800 may be an example of the methods 500, 600, and/or 700.

At block 805, the method may include receiving from a first device at a first location a first media file associate with a user. The first electronic media file may include a unique identifier obtained from the user at the first location. The operations of block 805 are, in some examples, performed by the content aggregation module 220, as described above with reference to FIG. 2

At block 810, the method may include receiving from a second device at a second location a second electronic media file associated with the user. The second electronic media file may include the unique identifier obtained from the user at the second location. The operations of block 810 are, in some examples, performed by the content aggregation module 220, as described above with reference to FIG. 2

At block 815, the method may include associating the user with a unique identifier, which may be based at least in part on data received from the user via a third device. The operations of block 815 are, in some examples, performed by the user associate module 215, as described above with reference to FIG. 2.

At block 820, the method may include receiving data indicative of a telephone number from the user. The telephone number may be obtained from the user at the first location. The operations of block 820 are, in some examples, performed by the network communication module 250, as described above with reference to FIG. 2.

At block 825, the method may involve generating a multimedia file for the user, which may be based at least in part on the associate of the user with the unique identifier. The multimedia file may include the first and second electronic media files having the unique identifier. The operations of block 825 are, in some examples, performed by the chapter creation module 225, as described with reference to FIG. 2. The content 300 described with reference to FIG. 3 may be an example of a multimedia file generated in the method 800.

At block 830, the method may include transmitting a link for the multimedia file to the user utilizing the telephone number. The operations of block 830 are, in some examples, performed by the network communication module 250, as described above with reference to FIG. 2.

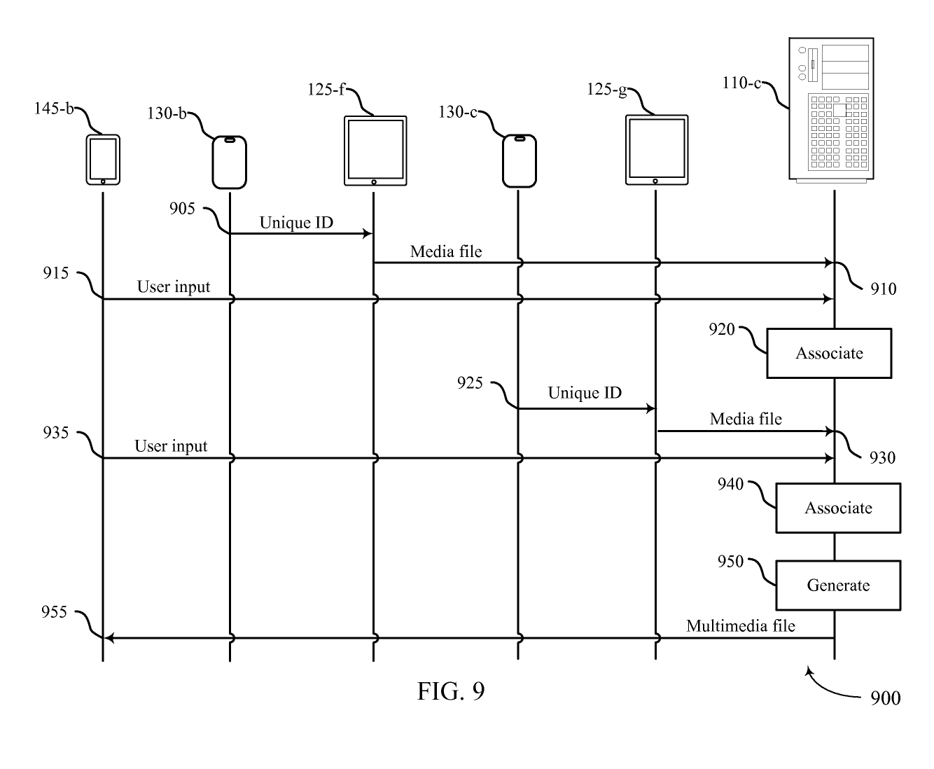

FIG. 9 illustrates an example of a process flow for dynamic content aggregation in accordance with various aspects of the present disclosure. The process flow 900 may include a central server 110-c, venue terminals 125-f and 125-g, identification devices 130-b and 130-c, and a user terminal 145-b, each of which may be examples of the corresponding components of the system 100 and 200 of FIGS. 1 and 2.

The identification device 130-b may include a unique identifier, which may be obtained via message 905 by venue terminal 125-f. The venue terminal 125-b may be located at a first venue, and it may obtain the unique identifier from the identification device 130-b, and thus a user, at the first venue. The central server 110-c may receive an electronic media file, which may be associated with the user, in message 910 from the venue terminal 125-f.

A user may access the central server 110-c through a web-based portal via user terminal 145-b. The user may access and/or create a user account, and the user may, in message 915, transmit a user input, which may include the unique identifier of the identification device 130-b, to the central server 110-c. The central server 110-c may thus receive data from the user via the user terminal 145-b, and the data may include the unique identifier. Accordingly, the central sever 110-c may associate the user and the unique identifier at block 920 based, at least in part, on the data received from the user.

The identification device 130-c may include a unique identifier different from the unique identifier of identification device 130-b, and which may be obtained via message 925 by venue terminal 125-g. The venue terminal 125-g may be located at a second venue, and it may obtain the unique identifier from the identification device 130-c, and thus a user, at the second venue. The central server 110-c may receive an electronic media file, which may be associated with the user, in message 930 from the venue terminal 125-g.

A user may access the central server 110-c through a web-based portal via user terminal 145-b. The user may access a previously created user account, and the user may, in message 935, transmit a user input, which may include the unique identifier of the identification device 130-c, to the central server 110-c. The central server 110-c may thus receive data from the user via the user terminal 145-b, and the data may include the unique identifier of identification device 130-c. Accordingly, the central sever 110-c may associate the user and the unique identifier at block 940 based, at least in part, on the data received from the user.

The user may then be associated with several unique identifiers, including those of identification devices 130-b and 130-c. A users account may, for example, include a number of unique identifiers as attributes. In some examples, there is a significant temporal difference between venue terminal 125-f obtaining the unique identifier from identification device 130-b and venue terminal 125-g obtaining the different unique identifier from identification device 130-c. For instance, a user may visit the first venue—which, as mentioned, may be associated with venue terminal 125-f—hours, days, weeks, months, or years before the user visits the second venue that may be associated with venue terminal 125-g. The central server 110-c may thus receive electronic media files from various venue terminals 125 of the span of hours, days, weeks, months, or years.

At block 950, the central server 110-c may generate a multimedia file for the user. The multimedia file may be based, to some extent, on the associations between the user and the unique identifiers; and the multimedia file may include electronic media files that include different unique identifiers, and which may have been captured at different times. The central server 110-c may then transmit, via message 955, the multimedia file to the user. Additionally or alternatively, the user may access the multimedia file on the central server 110-c via the web-based portal.

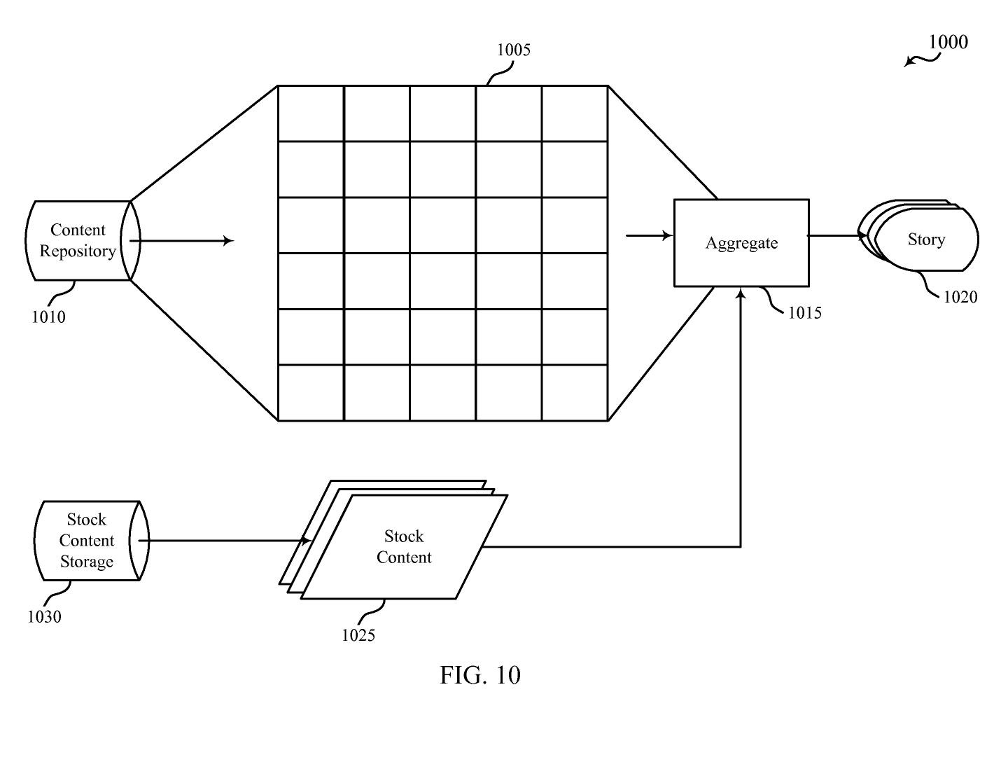

Next, FIG. 10 shows a flowchart 1000 illustrating a method for dynamic content aggregation in accordance with various aspects of the present disclosure. The method 1000 may be implemented by, for example, a central server 110 or its components, as described above with reference to FIGS. 1, 2, and 9. In some examples, the central server 110 may execute a set of codes to control the functional elements of the central server 110 to perform the functions described below. Additionally or alternatively, the central server 110 may perform aspects of the functions described below using special-purpose hardware.

A table 1005 represents various attributes, e.g., metadata, of content (e.g., electronic media files) stored at a content repository 1010. The content repository 1010 may be a memory module 240 (FIG. 2) of a central server 110, or it may be a content repository 112 (FIG. 1) and it may store electronic media files from various venues. In some examples, the content repository 1010 may store third-party social media content and/or UGC associated with a user. Additionally or alternatively, the content repository 1010 may store chapters or stories (e.g., multimedia files) previously generated for a user. The table 1005 may be searchable by, for example, date, time, location, venue, and/or vacation type, which may all be metadata of electronic media files and/or multimedia files. All content (e.g., electronic media files, multimedia files, etc.) received by a central server 110 and associated with a user may thus be searchable and retrievable by the user.

Further, in some examples, various content, chapters, and/or stories may be aggregated to form new chapters and or stories 1020. That is, some or all aspects of a multimedia file previously generated for a user may be accesses by the central server 110 and utilized to generate other multimedia files. Additionally or alternatively, stock content 1025 may be retrieved from a stock content storage location 1030 and aggregated at block 1015 to generate new stories 1020 (e.g., multimedia files). The stock content 1025 may be stock content media files as described above; and the stock content and storage 1030 may be an aspect of the memory module 240 (FIG. 2) and/or the content repository 112 (FIG. 1).

By way of example, a user may search the content repository 1010 for all content associated with the user and related to Hawaiian vacations—e.g., all electronic media files associated with the user and obtained from venue terminals 125 (FIG. 1) at venues in Hawaii. The search may be accomplished utilizing various aspects of the central server 110-a of FIG. 1, including the content aggregation module 220 and the repository storage and retrieval module 235, for example. The method 1000 may thus be used to provide an aggregation 1015 of one or more stories 1020 of the user's Hawaiian vacation. Furthermore, the method 1000 may facilitate a virtual bookshelf of user stories, as discussed above.

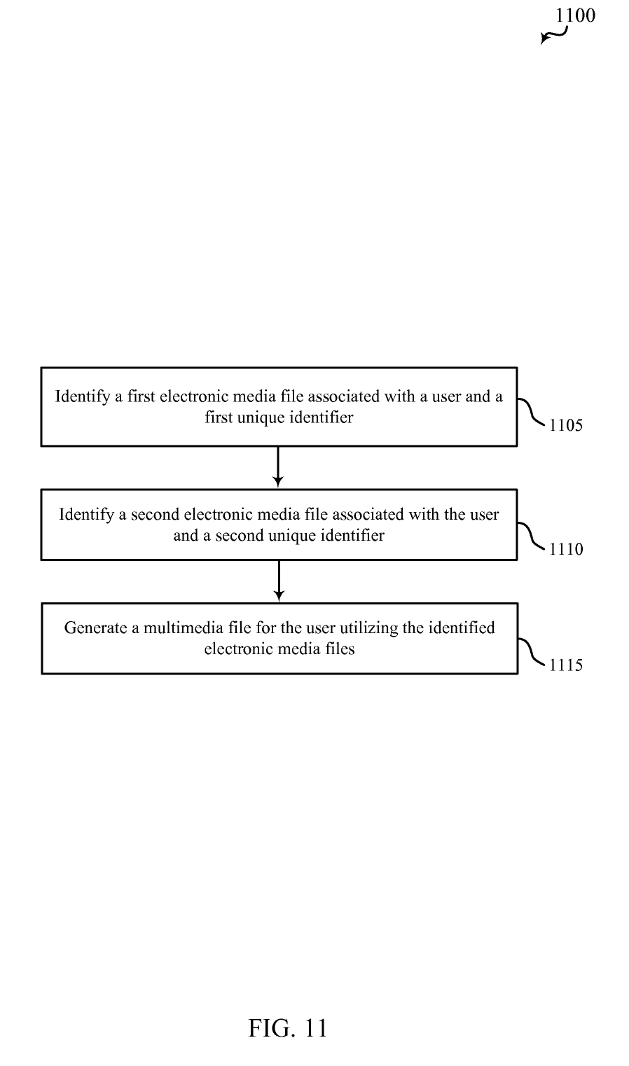

FIG. 11 shows a flowchart illustrating a method 1100 for dynamic content aggregation in accordance with various aspects of the present disclosure. The method 1100 may be implemented by, for example, a central server 110 or its components, as described above with reference to FIGS. 1, 2, and 9. In some examples, the central server 110 may execute a set of codes to control the functional elements of the central server 110 to perform the functions described below. Additionally or alternatively, the central server 110 may perform aspects of the functions described below using special-purpose hardware. The method 1100 may be an example of the method 1000.

At block 1105, the method may include identifying a first electronic media file associated with a user and a first unique identifier. The first electronic media file may include metadata indicative of a first time at which the electronic media file was captured and/or transmitted from venue terminal The operations of block 1105 are, in some examples, performed by the repository storage and retrieval module 235, as described above with reference to FIG. 2.

At block 1110, the method may include identifying a second electronic media file associated with the user and a second unique identifier. The second electronic media file may include metadata indicative of a second time at which the electronic media file was captured and/or transmitted from venue terminal, where the second time may be different from the first time at which the first electronic media file was captured. The operations of block 1110 are, in some examples, performed by the repository storage and retrieval module 235, as described above with reference to FIG. 2.

At block 1115, the method may involve generating a multimedia file for the user utilizing the identified first and second electronic media files. The multimedia file may be generated with input from a user and/or as a result of a user's search of a content repository. The operations of block 1115 are, in some examples, performed by the chapter creation module 225, as described above with reference to FIG. 2. The content 300 described with reference to FIG. 3 may be an example of a multimedia file generated in method 1100.

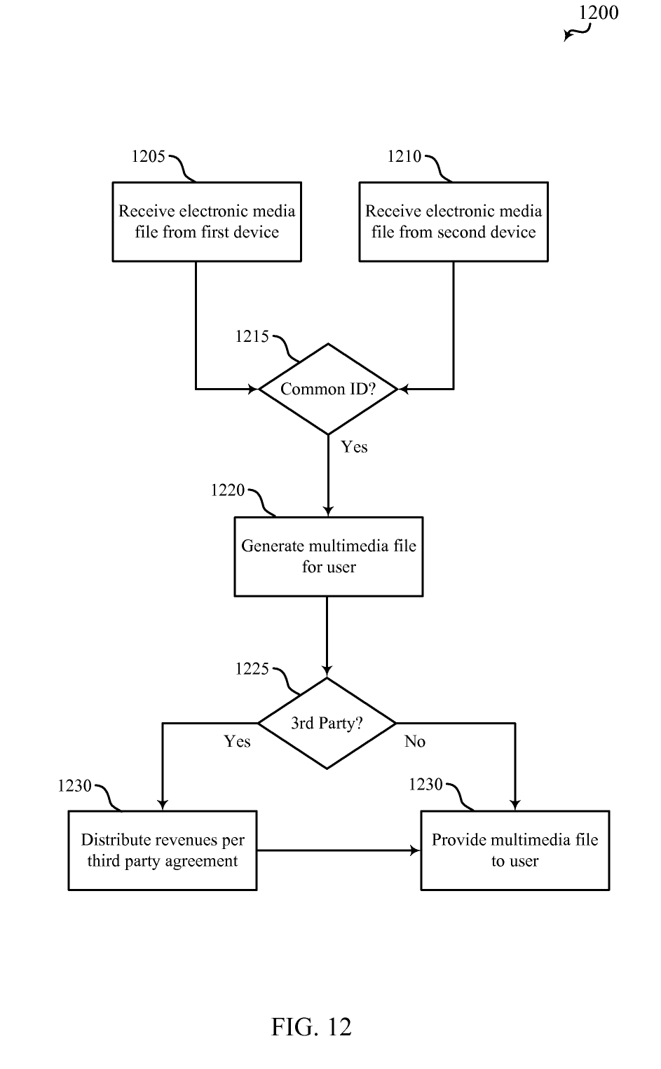

FIG. 12 shows a flowchart illustrating a method 1200 for dynamic content aggregation in accordance with various aspects of the present disclosure. The method 1200 may be implemented by, for example, a central server 110 or its components, as described above with reference to FIGS. 1, 2, 4, and 9. In some examples, the central server 110 may execute a set of codes to control the functional elements of the central server 110 to perform the functions described below. Additionally or alternatively, the central server 110 may perform aspects of the functions described below using special-purpose hardware.

At block 1205, the central server 110 may receive a first electronic media file from a first device, which may be venue terminal 125 (FIG. 1), which may be owned and operated by owner of the central server 110. At block 1210, the central server may receive a second electronic media file from a second device, which may be a venue terminal 125 owned and operated by a third-party contractor.

The first and second electronic media files may each include a unique identifier obtained by a venue terminal 125; the unique identifiers for the first and second electronic media files may be the same or different. That is, the unique identifiers may or may not have been obtained from a common identification device 130 (FIG. 1). At block 1215, the central sever 110 may determine whether the unique identifiers of the first and second electronic media files are the same. If so, the central server 110, at block 1220, may generate for the user a multimedia file including both the first and second electronic media files.

At block 1225, the central server 110 may determine whether electronic media files utilized to generate a multimedia file where received from a third-party. In some cases, third-party-provided content (e.g., electronic media files) may be identified by metadata of the content, which may include an indication of the author or creator, and which may be known to the central server 110 to be indicate a third party. For instance, the central server 1225 may determine whether either of the first or second electronic media files were received from a venue terminal 125 owned and/or operated by a third-party. If so, at block 1230, the central server 110 may cause revenue received for a sale of the multimedia file to be distributed according to an agreement with the third party. For instance, a third party may be given a pro rata share of revenue according to the extent the third party's content (e.g., electronic media files) appears in a story (e.g., a multimedia file). In other cases, a third party's revenue share may be a function of the temporal relationship between the sale and creation of the third party's content. For example, a third party may be entitled to X% of revenue for a sale occurring within one month of generating and providing content, while the third party may only be entitled to (X-50)% of the revenue share for subsequent sales.

The distribution of revenue may occur before, after, or concurrently with providing the generated multimedia file to a user, at block 1230. If a generated multimedia file does not include third party content, as determined at block 1225, the central server may, at block 1230, provide the multimedia file to the user without distributing revenue to third parties.

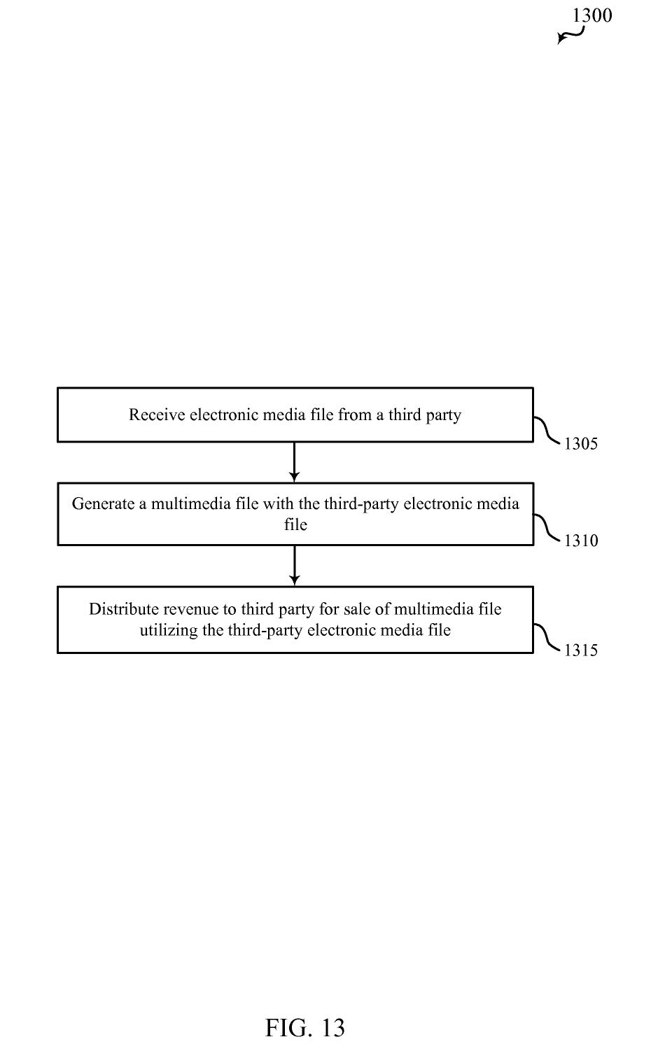

FIG. 13, shows a flowchart illustrating a method 1300 for dynamic content aggregation in accordance with various aspects of the present disclosure. The method 1300 may be implemented by, for example, a central server 110 or its components, as described above with reference to FIGS. 1, 2, 4, and 9. In some examples, the central server 110 may execute a set of codes to control the functional elements of the central server 110 to perform the functions described below. Additionally or alternatively, the central server 110 may perform aspects of the functions described below using special-purpose hardware. The method 1300 may be an example of the method 1200.

At block 1305, the method may include receiving electronic media files from a third party. The operations of block 1305 are, in some examples, performed by the content aggregation module 220, as described with reference to FIG. 2.

At block 1310, the method may include generating a multimedia file with the third-party electronic media file. The operations of block 1310 are, in some examples, performed by the chapter creation module 225, as described with reference to FIG. 2.

At block 1315, the method may include distributing revenue to the third party for a sale of the multimedia file generated with the third-party electronic media file. The operations of block 1315 are, in some examples, performed by the processor module 205, as described with reference to FIG. 2.

It should be noted that methods 500, 600, 700, 800, 1000, 1100, 1200, and 1300 describe possible implementations, and that the operations and the steps may be rearranged or otherwise modified such that other implementations are possible. In some examples, aspects from two or more of the methods 500, 600, 700, 800, 1000, 1100, 1200, and 1300 may be combined.

The detailed description set forth above in connection with the appended drawings describes example embodiments and does not represent all the embodiments that may be implemented or that are within the scope of the claims. The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.)

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of at least one of A, B, or C means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of aggregating content, comprising:
receiving from a first device at a first location a first electronic media file associated with a user, wherein the first electronic media file includes a unique identifier obtained from the user at the first location;
receiving from a second device at a second location a second electronic media file associated with the user, wherein the second electronic media file includes the unique identifier obtained from the user at the second location;
associating the user with the unique identifier based at least in part on data received from the user via a third device; and
generating a multimedia file for the user based at least in part on the association of the user with the unique identifier, wherein the multimedia file comprises the first and second electronic media files.

2. The method of claim 1, further comprising:
receiving a stock content media file associated with at least one of the first or second locations, wherein the multimedia file comprises the stock content media file.

3. The method of claim 1, further comprising:
identifying user-generated content (UGC) from the third device or from a third-party server based at least in part on metadata of the first electronic media file, metadata of the second electronic media file, the first location, or the second location; and
acquiring the identified UGC from the third device or from the third-party server;
wherein the multimedia file comprises the UGC.

4. The method of claim 3, wherein identifying the UGC comprises:
searching an application programming interface (API) for at least one of an album title, an album description, a photo title, a photo description, a date, a time, or a geographic location.

5. The method of claim 1, wherein metadata of the first and second electronic media files comprises the unique identifier.

6. The method of claim 1, wherein associating the user with the unique identifier comprises:
receiving data indicative of the unique identifier from the user via the third device; and
storing the unique identifier as an attribute of an account created by the user.

7. The method of claim 1, further comprising:
receiving data indicative of a telephone number obtained from the user at the first location.

8. The method of claim 7, further comprising:
transmitting a hyperlink for the multimedia file to the user utilizing the telephone number.

9. The method of claim 7, wherein the telephone number is linked with the unique identifier at the first location, and wherein metadata of the first and second electronic media files comprise the telephone number.

10. An apparatus for aggregating content, comprising:
a processor;
memory in electronic communication with the processor; and
instructions stored in the memory, the instructions executable by the processor to:
receive from a first device at a first location a first electronic media file associated with a user, wherein the first electronic media file includes a unique identifier obtained from the user at the first location;
receive from a second device at a second location a second electronic media file associated with the user, wherein the second electronic media file includes the unique identifier obtained from the user at the second location;
associate the user with the unique identifier based at least in part on data received from the user via a third device; and
generate a multimedia file for the user based at least in part on the association of the user with the unique identifier, wherein the multimedia file comprises the first and second electronic media files.

11. The apparatus of claim 10, wherein the instructions are executable by the processor to:
receive a stock content media file associated with at least one of the first or second location, wherein the multimedia file comprises the stock content media file.

12. The apparatus of claim 10, wherein the instructions are executable by the processor to:
identify user-generated content (UGC) from the third device or from a third-party server based at least in part on metadata of the first electronic media file, metadata of the second electronic media file, the first location, or the second location; and
acquire the identified UGC from the third device or from the third-party server;
wherein the multimedia file comprises the UGC.

13. The apparatus of claim 12, wherein the instructions are executable by the processor to:
search an application programming interface (API) for at least one of an album title, an album description, a photo title, a photo description, a date, a time, or a geographic location.

14. The apparatus of claim 10, wherein metadata of the first and second electronic media files comprises the unique identifier.

15. The apparatus of claim 10, wherein the instructions are executable by the processor to:
receive data indicative of the unique identifier from the user via the third device; and
store the unique identifier as an attribute of an account created by the user.

16. The apparatus of claim 10, wherein the instructions are executable by the processor to:
receive data indicative of a telephone number obtained from the user at the first location.

17. The apparatus of claim 16, wherein the instructions are executable by the processor to:
transmit a hyperlink for the multimedia file to the user utilizing the telephone number.

18. A non-transitory computer-readable medium storing code for aggregating content, the code comprising instructions executable for:
receiving from a first device at a first location a first electronic media file associated with a user, wherein the first electronic media file includes a unique identifier obtained from the user at the first location;
receiving from a second device at a second location a second electronic media file associated with the user, wherein the second electronic media file includes the unique identifier obtained from the user at the second location;
associating the user with the unique identifier based at least in part on data received from the user via a third device; and
generating a multimedia file for the user based at least in part on the association of the user with the unique identifier, wherein the multimedia file comprises the first and second electronic media files.

19. The non-transitory computer-readable medium of claim 18, wherein the instructions are executable for:
receiving a stock content media file associated with at least one of the first or second locations, wherein the multimedia file comprises the stock content media file.

20. The non-transitory computer-readable medium of claim 18, wherein the instructions are executable for:
identifying user-generated content (UGC) from the third device or from a third-party server based at least in part on metadata of the first electronic media file, metadata of the second electronic media file, the first location, or the second location; and
acquiring the identified UGC from the third device or from the third-party server;
wherein the multimedia file comprises the UGC.
